(19) United States
(12) Patent Application Publication
(10) Pub. No.: US 2004/0220843 A1
(43) Pub. Date: Nov. 4, 2004

(54) Integrated method for sustained business improvement

(75) Inventor: Johann Walter, Erlangen (DE)

Correspondence Address: SCHIFF HARDIN, LLP, PATENT DEPARTMENT, 6600 SEARS TOWER, CHICAGO, IL, 60606-6473, US

(73) Assignee: Siemens Aktiengesellschaft

(21) Appl. No.: 10/427,867

(22) Filed: May 1, 2003

(51) Int. Cl. G06F 17/60

(52) U.S. Cl. 705/7

(57) ABSTRACT

In an integrated method for sustained business improvement, an overall loop is repeatedly and continuously executed for the ultimate purpose of identifying processes within a business and comparing those processes to objective standards of excellence. By continuously and repeatedly executing the overall loop, it is assured that sustained business development will be achieved. The overall loop includes individual loops, which are respectively executed to generate a business map, a business roadmap, a business drive map, a process map, an object map, an organization map, a data map, an information map, a performance map and an excellence map.

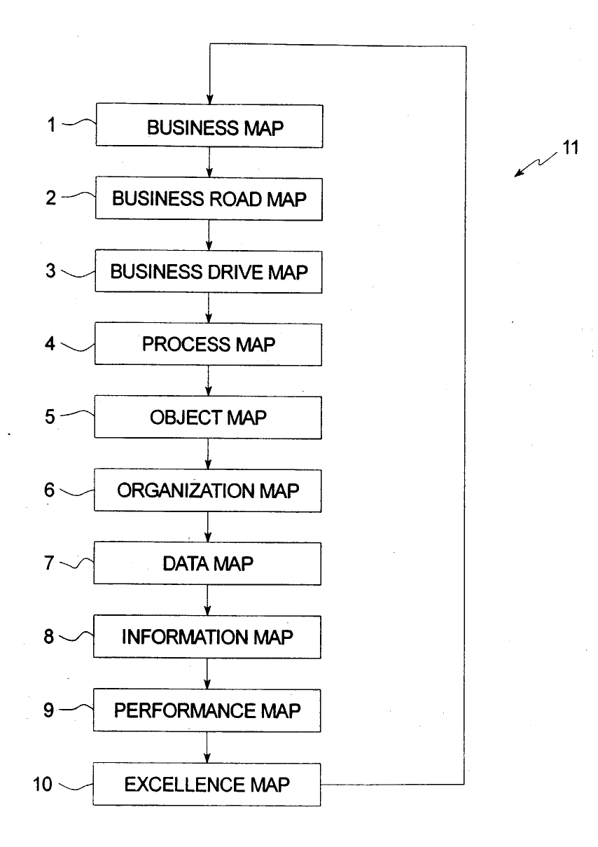

### BACKGROUND OF THE INVENTION

1. Field of the Invention

The present invention is directed to a method for modeling and analyzing a business or enterprise in order to obtain sustained improvement in the business or enterprise.

2. Description of the Prior Art

Various types of methods and models for business improvement are known, variously referred to as “business re-engineering,” “processing re-engineering,” “continuous improvement,” etc. Each of these known techniques proceeds from different prerequisites. None of these known methods has succeeded in assuring sustained positive business development. It is also known to customize one or more of these methods for specific arenas or types of businesses. The objective of many of these methods is a short-term improvement that is often oriented to the interests of the shareholders.

The business of operating a medical clinic, for example, has attributes that exemplify the deficiencies of such known methods. Moreover, these deficiencies apply to other types of business concerns comparable in size and structure to a medical clinic, particularly in the mid-sized range. For such clinics and businesses, the specific task that should be accomplished by the clinic is often unclear and there is not a consensus as to the direction that the clinic should develop in the future. There similarly is a lack of consensus as to how to measure success (success factors) in the development of the clinic. Additionally, generally there are no readily available descriptions of the day-to-day processes undertaken within the clinic.

The organization of such clinics is functionally structured according to departments, and the employees in a given department do not always collaborate in a team for a common, specified purpose.

Moreover, there is often no definitive relationship between the processes practiced by the clinic and available data. Data are in fact generated and collected in large quantities, but are not organized or identified in a manner making the data useful for measuring the success of changes in the clinic's processes, or other attempts at improvements. Additionally, the collected data are not organized in a manner to allow conclusions regarding the overall performance of the clinic to be made. In general, conventionally the performance of the clinic can be discerned only on the basis of the financial numbers, patient satisfaction, employee satisfaction and the like. Analysis of the processes involved in the operation of the clinic over a relatively long time span are generally not available. This is in part because in order to measure success or failure, or change in general, over a longer time span it is necessary to be able to identify benchmarks at various points in time for comparison to each other. The ability to generate such benchmarks from the collected data is, in general, lacking.

There are, of course, standardized auditing procedures, such as ISO 9000 or similar QM standards (KTQ) which are occasionally employed, but these are not, and are not intended to be, a critical analysis of the business procedures and processes in the sense of an overall assessment and review.

Techniques for analysis of processes related to work flow, for example, are available for some departments of a clinic, such as radiology. These known techniques, however, are almost always limited to individual departments or individual aspects of a particular department, for example, purchasing of supplies and maintenance of an inventory. The analysis of these processes often ensues by means of detailed flowcharts, accompanied by workflow simulations. These assessments are driven by the constant problems associated with rising costs in the healthcare sector, and therefore these techniques almost always represent somewhat isolated solutions for reducing, or at least not increasing, the costs associated with operating the department. These techniques, therefore, do not take into account, and are not intended to take into account, whether the course of action resulting from the analysis is advantageous or disadvantageous for the overall operation of the clinic in which the department is located.

Despite individual examples of success, healthcare costs continue to rise annually on average. Moreover, the satisfaction of patients with the care received at clinics is, in general, decreasing. Moreover, the job satisfaction level of many employees, such as nurses and medical technicians, is relatively low.

### SUMMARY OF THE INVENTION

It is an object of the present invention to provide an integrated method for sustained business improvement which overcomes the aforementioned problems of known techniques.

It is a further object of the present invention to provide such a method which has particular applicability and utility in the field of medical clinics.

The above object is achieved in accordance with the principles of the present invention in an integrated method for sustained business improvement which is based on combining individual models and methods that are known for business activities, to create a new system that is optimally suited to the purpose of identifying ways to achieve sustained business improvement, and to also employ new (not previously known) techniques, combined with the known techniques, in a unique structure which results in an integrated and universally useable method. The method can be applied to any type of company or organization in the public and non-public domains. The method is able to achieve sustained improvement in the business because it is based on “basic laws” of economics of continuous improvement, as established by Deming in the PDCA (Plan-Do-Check-Act) in the early 1950's. The method is based on improvement loops that contain this PDCA cycle as a basic principle. Many small loops are combined in accordance with the inventive method to form an overall complete and comprehensive loop for sustained business improvement.

The model is composed of ten loops which, in combination, form one large, comprehensive loop. The designations of the loops are oriented to the result that is derived from the activities within a loop. The individual loops of the inventive method are as follows:

1. Business map

2. Business roadmap

3. Business drive map

4. Process map

5. Object map

6. Organization map

7. Data map

8. Information map

9. Performance map

10. Excellence map.

These loops are executed repeatedly, regardless of whether an organizational unit applies to the procedure associated with the loop during each execution. The repeated application offers a dependable assurance that the organizational unit can show sustained success and is proceeding in the correct direction in order to achieve such success. The sustained success is represented, for example, by a positive business development and/or in continuously increasing customer and employee satisfaction.

The ten loops preferably are executed in a sequence beginning with the first loop (business map), but also can be executed in parallel. The important factor is that all of the loops are repeatedly executed. The number of execution cycles of the loops is determined on the basis of the requirements of the particular business and the dynamics of the field or market in which the business is competing.

The result of each execution of a loop is used as the input for the next execution of that loop, and may also be used as an input, or one of multiple inputs, for the execution of another loop. For example, the result of the business map loop can form the basis for the activities in the last loop, the excellence map. The result of the excellence map, in turn, influences the business map, the business roadmap, the business drive map, and possibly others.

The ten loops can be assigned to four categories. Loops 1 through 3 represent the strategic aspects of a company or an organization. Loops 4 through 6 represent the operative conversion of the business strategy of the organization. Loops 7 through 9 are concerned with the results of the activity of a particular undertaking. Loop 10, which is an assessment and review loop, forms the parameters and defines the transition to a new stage in the operation of the business in order to achieve sustained improvement.

### DESCRIPTION OF THE DRAWING

The single FIGURE is a flowchart of an integrated method for sustained business improvement in accordance with the present invention.

### DESCRIPTION OF THE PREFERRED EMBODIMENTS

As discussed above, current management methods focus on certain aspects of a business, for example, strategic planning or procedure or quality management, proceeding from a business map that takes into account the interests of the primary persons affected by the business (stakeholders). The operative conversion processes for changing the business are taken into account in a roadmap. The objects are allocated therein to data structures that supply the stakeholders with the necessary information. The analysis of the date with respect to strategic goals leads to particular recommended measures. A critical review closes the circle back to the business map. The inventive method achieves a simple, independent integrated action model that is available based on a few established models. These models are, for example, Stakeholder Orientation According to BSC (Balanced Score Card), Process Modeling According to SCOR (Supply Chain Operations Reference Model), Assessment According to EFOM or Baldrige or Deming, Continuous Improvement According to PDCA.

The inventive method includes ten repeatedly executed individual loops 1-10, integrated into an overall repeatedly executed loop 11.

A general description of the content and objectives of each loop 1-10 is as follows.

Loop 1 (business map) takes into account all expressions of a company or an organization, starting with its products, customers, employees, vendors and business partners.

Loop 2 (business roadmap) models the vision and mission of the business organization.

Loop 3 (business drive map) uses the results from loop 1 (business roadmap) to identify more specific business drivers that are related to each other, as a preparation for execution of loop 4 (process map).

Loop 4 (process map) converts strategic goals into specific activities.

Loop 5 (object map) allocates objects such as input, output, role, method, rules, IT applications, metrics, etc. to the processes identified in loop 4.

In loop 6 (organization map) activities in the processes and process elements are allocated to the employees in the company or organization, the business partners and customers, and the collaboration of all participants to achieving the designated goals is thus assured.

In loop 7 (data map) data are made available to the persons or organizations responsible for decision making, the data being relevant and necessary for the defined collaboration.

In loop 8 (information map) the data are edited and made available worldwide via suitable information systems.

In loop 9 (performance map) the information and data are allocated to the processes and products and the performance of the company or organization thus becomes transparent in all aspects and details.

In loop 10 (excellence map) the company or organization critically questions and repeatedly evaluate the results that have been achieved in order to advance further improvements by means of constant learning.

The overall loop 11 is repeatedly executed, as are the individual loops 1-10.

As noted above, the method is applicable to all types of businesses, and has particular applicability to clinics and hospitals. The inventive method allows the entire activity of a business to be presented on the basis of the aforementioned ten maps. Following an initial execution of each of the loops 1-10, only changes and improvements need be assessed in subsequent executions. The simple structure facilitates communication with all participants within the business or organization, because the individual maps build on and mesh with each other and yield an overall result that is repeatedly utilized.

A more detailed description of the activities of each loop 1-10 is as follows.

First and foremost, a critical inventory must be undertaken of the overall condition of a business. In this critical inventory, the overall standpoint of the business will be identified as will the particular areas of competency of the business, as well as an identification of those who are affected by the business, namely customers or patients and their relatives, partners, suppliers, shareholders, etc. The classes of employees will be identified, as well as their organizations. Current processes and procedures that are in place will be identified. Areas of competition or other activity in which the business is present will also be identified. As a result of the answers to these inquiries, the business map is derived in loop 1. A business map, in general, is a map that states exactly where the business or clinic stands in the overall business environment.

Even a clinic which fulfills a public health mandate must consider where, in the future, it wishes to make a contribution to maintaining the health of the general public, viewed in the context of economic forces and restrictions. For example, a clinic may decide its future is best suited for primary care of accident victims, or planned creation of quality of life resulting from particular medical procedures, such as a hip operation, for example, or in the care of patients suffering from particular mental illnesses. Proceeding from the actual status described in the business map, these considerations lead to a business roadmap in loop 2, with a defined destination that should be reached in the years.

When the goal toward which the business or clinic wishes to develop in the sense of a future vision is clear, as a result of the execution of loop 2, the business or clinic can consider what actions are needed to reach this goal. These so-called business drivers, key performance indicators, or critical success factors, preferably are oriented to the stakeholders (customers, patients, relatives, vendors, employees, etc.). The balanced scorecard method of Kaplan and Norton is available for this purpose. Execution of the driver map in loop 3 identifies these specific programs and projects. When loops 1, 2 and 3 are viewed together, three maps arise from strategic considerations that make clear to each stakeholder as to where the business stands, where it wishes to go, and how it wishes to accomplish its goals for the future.

Execution of the process map in loop 4 identifies the appropriate business processes for implementing the results defined in loops 1, 2 and 3. The process map can be subdivided into management processes (strategic planning, business review, strategic control) operative processes (customer relationship and management (CRM), supply chain management (SCM), product lifecycle management (PLM), etc.) and support processes (quality management, information management, financial management, partnership management etc.). It is also meaningful and necessary in a clinic to determine how the patient enters into the achievement of the defined goals, as opposed to a purely functional approach.

CRM is a process oriented toward the customer. The first concern is to understand the customer who, in the context of a clinic, is a patient. A first concern is to understand the patient himself or herself, the patient's relatives, and the patient's health needs in general, and to derive appropriate procedures therefrom. The appointment times is made based on this information, and defining conditions for a stay at the clinic and for therapy. In order to take patient satisfaction into account, feedback from the patient and his or her relatives is obtained at an early point in time of the patient's treatment in order to improve the post-clinical recovery process. These considerations apply not only to a planned stay at a clinic, but also to emergency visits, although processes related to emergencies must be expressed somewhat differently.

In the context of a clinic, the concept of a supply chain may be somewhat artificial. In a clinic, the classical processes which are analyzed are admission, diagnostics, therapy, healing, rehabilitation and discharge. The patient is the object of these processes. The “output of these processes is a healthy patient. PLM already plays an important in many clinics. In the context of the inventive method, PLM is used to develop new treatment methods, and to introduce and validate these methods as standard procedures in the clinic's therapeutic process.

Once the processes have all been identified and presented in the process map in loop 4, questions relating to process-relevant objects can be answered in loop 5 in the object map. Details needed by the process participants in order to be able to work optimally and efficiently in the process, for example, patient admission and discharge, are defined in the object map. Such objects include input, output, regulation roles, documentation, IT applications, etc. Processes are oriented to the patient, rather than to departments. In some cases, such objects can be implemented by, or involve, filling out forms, such as in the context of the laboratory, radiology or surgery, in order to focus and optimize competency.

The one of the most important tasks in business improvement tasks in business improvement is to clarify and precisely define the rolls of the participants and their relation to the process or processes. The connection between the process or processes, the role description of the participants in the process, and the organization thereof are produced in loop 6 in the organizational map. In general, loops 4, 5 and 6 are concerned with the operative conversion of the strategic direction that was developed in loops 1, 2 and 3. The maps employed for this purpose transparently show all stakeholders how the processes are arranged in the clinic or business, identify the needs in terms of objects in the processes, and identify how the organization relates to the processes.

When a patient passes through the various processes in a clinic, data regarding the patient and the activities experienced by the patient at the clinic are required. The patient data acquired via the admission process must be available for all of the other subsequent processes. The attributes that characterize the patient are defined in a data structure in the data map of loop 7. As the patient proceeds through further processes within the clinic, more data are collected and can be allocated to the aforementioned attributes. The same applies regarding data regarding the patient's relatives, as well as suppliers to clinic and other objects in the process. The data map is defined dependent on a designation of which data a process participant, or a relative of the process participant should supply so that other processes have the necessary inputs.

The data acquired in the data map of loop 7 do not represent meaningful and usable information. Usable information arises by the organization and arrangement of the data. Moreover, it is of little use if data are acquired in a particular process, such as radiology, but are not available within a short time in a subsequently occurring process, such as surgery, because the infrastructure of the data networks is inadequate. Insuring such organization and availability of data is accomplished in loop 8, in the information map, which also is directed to making the data available by suitable networks, for example, the Internet, on a worldwide basis. The data map of loop 7 serves as the input to the information map in loop 8.

When the information from the processes can be allocated to the outputs thereof in the form of specified characteristics, and can be allocated in a further compression step to the business drivers determined in step 3, conclusions regarding the performance of the processes, as well as other business-relevant procedures can be made. These conclusions are obtained in loop 8 in the performance map. The characteristics are acquired over a longer time span by repeated execution of the various loops in the inventive method, and are placed into relationship with corresponding goals and compared to benchmark data. This results in a very profound picture regarding the performance of a business or a clinic over time, which can be compared to comparable pictures regarding other businesses or clinics.

In the loop 10, the performance of the clinic based on a critical review of the processes and the direction of patient satisfaction, employee satisfaction, social reputation, and acceptance by shareholders, etc. arises in an excellence map. The term excellence map represents the purpose of the analysis, i.e. to critically analyze the aforementioned factors to achieve excellence in every factor. The excellence map represents a measure, which can be reviewed by any interested party, as to the degree of excellence that has been achieved for all of the relevant factors. The strengths and improvement areas are identified in this assessment, and serve in the continuing promotion of activities which have proven beneficial, and to indicate changes which may be necessary with regard to factors for which the level of excellence is unsatisfactory. The assessment is a critical evaluation from the point of view that there will always be something to improve. Financial aspects are, of course, a part of this evaluation, and assure that the interests of shareholders will be taken into account, however, the excellence map is intended to ensure that the interests of all stakeholders are measured according to a level of excellence.

After execution of loop 10, the overall loop 11 returns to loop 1 and the output from the excellence map in loop 10 is used as an input for the business map in loop 1. The repeated execution of all of loops 1-10 ensures that business success will be sustained.

Although modifications and changes may be suggested by those skilled in the art, it is the intention of the inventor to embody within the patent warranted hereon all changes and modifications as reasonably and properly come within the scope of his contribution to the art.

I claim as my invention:

1. An integrated method for sustained business improvement comprising the steps of:
repeatedly and continuously executing an overall loop using an output for each execution of said overall loop as an input for a next execution of said loop to monitor success of a business with respect to standards for business improvement, execution of said overall loop including: executing a loop to generate a business map of said business;
using said business map, executing a loop to generate a business roadmap of said business;
using said business map, executing a loop to generate a business roadmap of said business;
using said business roadmap, executing a loop to generate a business drive map of said business;
using said business drive map, executing a loop to generate a process map of said business;
using said process map, executing a loop to generate an object map of said business;
using said object map, executing a loop to generate an organization map of said business;
using said organization map, executing a loop to generate a data map of said business;
using said data map, executing a loop to generate an information map of said business;
using said information map, executing a loop to generate a performance map; and
using said performance map, executing a loop to generate an excellence map.

2. A method as claimed in claim 1 wherein the step of executing a loop to generate a business map comprises generating a map of said business dependent at least on products of said business, customers of said business, employees of said business, partners of said business and shareholders of said business.

3. A method as claimed in claim 1 wherein the step of executing a loop to generate a business roadmap comprises defining overall business goals of said business.

4. A method as claimed in claim 1 wherein the step of executing a loop to generate a business drive map comprises identifying business drivers associated with goals of said business identified in said business roadmap.

5. A method as claimed in claim 1 wherein the step of executing a loop to generate a process map comprises identifying activities for implementing business drivers identified in said business drive map.

6. A method as claimed in claim 1 wherein the step of executing a loop to generate an object map comprises identifying objects including input, output, roles of participants, IT applications and metrics for activities identified in said process method.

7. A method as claimed in claim 1 wherein the step of executing said loop to generate an organization map comprises identifying an organization of said business to implement objects identified in said object map.

8. A method as claimed in claim 1 wherein the step of executing a loop to generate a data map comprises obtaining a data from predetermined participants in said business.

9. A method as claimed in claim 1 wherein the step of executing a loop to generate an information map comprises analyzing and organizing data obtained in said data map.

10. A method as claimed in claim 1 wherein the step of executing a loop to generate a performance map comprises defining processes for operating said business dependent on said information map.

11. A method as claimed in claim 1 wherein the step of executing a loop to generate an excellence map comprises comparing processes in said performance map to objective standards for excellence and determining whether said standards are satisfied.
